(19) United States
(12) Patent Application Publication
(10) Pub. No.: US 2022/0048746 A1
(43) Pub. Date: Feb. 17, 2022

(54) RETRACTABLE FRONT WHEEL STOP FOR A VEHICLE ALIGMENT LIFT

(71) Applicant: Scott David Folley, Rockville, MD (US)

(72) Inventor: Scott David Folley, Rockville, MD (US)

(21) Appl. No.: 16/990,971

(22) Filed: Aug. 11, 2020

(51) Int. Cl. B66F 7/28

(52) U.S. Cl. CPC B66F 7/28

(57) ABSTRACT

A retractable front wheel stop for an automotive alignment rack. The apparatus facilitates the ability to quickly stop a vehicle that has overrun the correct position on the alignment rack. This retractable wheel stop can also have an automatic extension capability, with a release mechanism that automatically resets the position of the retractable wheel stop.

### FIELD OF THE INVENTION

The present invention relates to repair and maintenance of vehicles that are driven on the road.

### BACKGROUND OF THE INVENTION

It is known that vehicles that are driven on the road need their wheels re-aligned when they are out of alignment. In order to properly and more easily re-align these vehicles, drive on lifts are used. These lifts incorporate a stationary front wheel stop. Over the years, as vehicles have become more and more aerodynamic, the spoilers or air dams, the part under the front bumper of these vehicles have gotten lower and lower to the ground.

This creates a problem for the previous design of drive on alignment lifts. The non-retractable front wheel stops interfere with the sensors, and or can damage the spoiler or air dam.

Thus, there is a need for a new front wheel stop design.

### SUMMARY OF THE PRESENT INVENTION

This Summary of the Invention is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is a retractable front wheel stop for a drive on alignment lift.

### BRIEF DESCRIPTION OF THE DRAWINGS

The current invention needs no drawings, as the drive on alignment lift and front wheel stops have been around for decades, and are easily understood. This invention is simply a version that retracts.

I claim:

1. A retractable front wheel stop for a drive on alignment lift.
